(19) United States
(12) Patent Application Publication
(10) Pub. No.: US 2021/0274801 A1
(43) Pub. Date: Sep. 9, 2021

(54) METHOD OF PRODUCING CHEESE CURD AND CHEESE PRODUCTS PRODUCED THEREOF

(71) Applicant: Jeff Blodgett, Polson, MT (US)

(72) Inventor: Jeff Blodgett, Polson, MT (US)

(73) Assignee: Jeff Blodgett, Polson, MT (US)

(21) Appl. No.: 16/811,140

(22) Filed: Mar. 6, 2020

(51) Int. Cl. A23C 19/076; A23C 19/045; A23C 3/03; A23C 9/13

(52) U.S. Cl. CPC A23C 19/076; A23C 9/1307; A23C 3/03; A23C 19/0455

(57) ABSTRACT

The invention involves a method of producing cheese curd. The method includes the step of providing a composition including a milkfat fluid. The method includes the step of pasteurizing the composition including the milkfat fluid. The method adjusts the temperature of the composition including the milkfat fluid to a predefined temperature allowing separation of cultures. The method includes the step of combining the composition including the milkfat fluid with diluted acetic acid. The method combines diluted acetic acid, or derivatives. The method adds the diluted acetic acid, or the derivatives to the milkfat fluid adjusted at the predefined temperature to separate whey, or milkfat. The method removes the separated milkfat from the whey and dry to isolate the cheese curd. The method stabilizes the cheese curd and combines the stabilized cheese curd with the milkfat fluid. The method combines yogurt in the stabilized cheese curd to add protein. The cheese curd remains stabilized after combining the yogurt.

### TECHNICAL FIELD

The present invention relates to cheese curd, in particular to a method of producing cheese curd and cheese products produced thereof.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in-and-of-themselves may also be inventions.

Typically, cottage cheese is a fresh cheese product which is mixture of a fresh dressing with curd. There are various recipes exist in the market that include cottage cheese flavouring. Different styles of cottage cheese are made from milk with different fat levels. Cottage cheese is a low calorie dairy product and a great source of protein, minerals and vitamins, desirable for use as snack, in salads and as an ingredient in meals. There is a need of a method to naturally increase the protein level in the cottage cheese without added carbohydrates, sodium, fat or sugars.

The disadvantages and limitations of traditional and conventional approaches will become apparent to the person skilled in the art through a comparison of the described composition and method with some aspects of the present disclosure, as put forward in the remainder of the present application and with reference to the drawings.

### SUMMARY

According to embodiments illustrated herein, there is provided a method of producing cheese curd and cheese products produced thereof.

According to embodiments illustrated herein, there is provided a method of producing cheese curd. The method includes the step of providing a composition including a milkfat fluid. The method includes the step of pasteurizing the composition including the milkfat fluid. The method includes the step of adjusting the temperature of the composition including the milkfat fluid to a predefined temperature allowing separation of a plurality of cultures. In an aspect, the predefined temperature facilitates the milkfat to be separated to achieve the correct consistency of cheese product that can be dried and stabilized enough to last the duration of shelf life is between about 150 degrees Celsius and 170 degrees Celsius. The method includes the step of combining the composition including the milkfat fluid with diluted acetic acid between about 1% and about 5%. The method includes the step of combining at least one of the diluted acetic acid, one or more derivatives, and a combination thereof. The method includes the step of adding at least one of the diluted acetic acid, the one or more derivatives, and a combination thereof to the milkfat fluid adjusted at the predefined temperature to separate at least one of whey, milkfat or butterfat, and a combination thereof. The method includes the step of removing the separated milkfat from the whey and drying to isolate the cheese curd. The method includes the step of stabilizing the cheese curd and combining the stabilized cheese curd with the milkfat fluid. The method includes the step of combining yogurt or a milkfat composition in the stabilized cheese curd to add protein. The cheese curd remains stabilized after combining the yogurt.

In an aspect, one or more derivatives include but not limited to one or more fruits, vinegar, and kombucha.

In an aspect, the present method alternatively uses organic acid or natural fruit combinations in order to replace the usage of diluted acetic acid.

Another aspect of the present invention relates to a method of producing a cheese product. The method includes the step of providing a composition including a milkfat fluid. The method includes the step of pasteurizing the composition including the milkfat fluid. The method includes the step of adjusting the temperature of the composition including the milkfat fluid to a predefined temperature allowing separation of a plurality of cultures. The method includes the step of combining the composition including the milkfat fluid with diluted acetic acid between about 1% and about 5%, The method includes the step of combining at least one of the diluted acetic acid, one or more derivatives, and a combination thereof. The method includes the step of adding at least one of the diluted acetic acid, the one or more derivatives, and a combination thereof to the milkfat fluid adjusted at the predefined temperature to separate at least one of whey, milkfat or butterfat, and a combination thereof. The method includes the step of removing the separated milkfat from the whey and drying to isolate the cheese curd. The method includes the step of stabilizing the cheese curd and combining the stabilized cheese curd with the milkfat fluid. The method includes the step of combining yogurt in the stabilized cheese curd to add protein. The cheese curd remains stabilized after combining the yogurt. The method includes the step of adding one or more ingredients into the combined mixture of the yogurt and the stabilized cheese curd to obtain the cheese product.

Accordingly, one advantage of the present invention at it combines yogurt and cheese curds to increase the protein content.

Accordingly, one advantage of the present invention is that it provides a method for producing sustainable cheese curd products having improved properties to stabilize in the yogurt and naturally add protein without adding sugar, calories, carbohydrates or unnecessary fats.

Accordingly, one advantage of the present invention is that the curd products are produced as a result of methods used to separate the curd protein and combined with using kombucha and yogurt to improve probiotic health benefits.

Other features of embodiments of the present invention will be apparent from accompanying drawings and from the detailed description that follows.

Yet other objects and advantages of the present invention will become readily apparent to those skilled in the art following the detailed description, wherein the preferred embodiments of the invention are shown and described, simply by way of illustration of the best mode contemplated herein for carrying out the invention. As we realized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description applies to any one of the similar components having the same first reference label irrespective of the second reference label.

FIG. 1 illustrates a flowchart of the method of producing cheese curd, in accordance with an alternative embodiment of the present invention.

FIG. 2 illustrates a flowchart of the present method of producing a cheese product, in another embodiment of the present invention.

### DETAILED DESCRIPTION

The present invention is best understood with reference to the detailed figures and description set forth herein. Various embodiments have been discussed with reference to the figures. However, those skilled in the art will readily appreciate that the detailed descriptions provided herein with respect to the figures are merely for explanatory purposes, as the methods and systems may extend beyond the described embodiments. For instance, the teachings presented and the needs of a particular application may yield multiple alternative and suitable approaches to implement the functionality of any detail described herein. Therefore, any approach may extend beyond certain implementation choices in the following embodiments.

References to “one embodiment”, “at least one embodiment”, “an embodiment”, “one example”, “an example”, “for example”, and so on indicate that the embodiment(s) or example(s) may include a particular feature, structure, characteristic, property, element, or limitation, but not every embodiment or example necessarily include that particular feature, structure, characteristic, property, element, or limitation. Furthermore, repeated use of the phrase “in an embodiment” does not necessarily refer to the same embodiment.

Unless defined otherwise, all technical and scientific terms used herein have the same meaning as commonly understood by one of the ordinary skills in the art to which this invention belongs. Although any method and material similar or equivalent to those described herein can also be used in the practice or testing of the present invention, the preferred methods and materials have been described. All publications, patents, and patent applications mentioned herein are incorporated in their entirety.

It is noted that as used herein and in the appended claims, the singular forms “a”, “and”, and “the” include plural referents unless the context clearly dictates otherwise. In the claims, the terms “first”, “second”, and so forth are to be interpreted merely as ordinal designations they shall not be limited in themselves. Furthermore, the use of exclusive terminology such as “solely”, “only”, and the like in connection with the recitation of any claim element is contemplated. It is also contemplated that any element indicated to be optional herein may be specifically excluded from a given claim by way of a “negative” limitation. Finally, it is contemplated that any optional feature of the inventive variation(s) described herein may be set forth and claimed independently or in combination with any one or more of the features described herein.

All references cited herein, including publications, patent applications, and patents, are hereby incorporated by reference to the same extent as if each reference were individually and specifically indicated to be incorporated by reference, and were set forth in its entirety herein.

The recitation of ranges of values herein is merely intended to serve as a shorthand method of referring individually to each separate value falling within the range, unless otherwise indicated herein, and each separate value is incorporated into the specification as if it were individually recited herein.

Definitions: The following terms shall have, for the purposes of this application, the respective meanings set forth below.

“Milkfat” or “butterfat” is the fatty portion of milk. Milkfat is mainly composed of triglycerides. Each triglyceride contains three fatty acids. Milkfat contains about 3% trans fats, which is slightly less than 0.5 grams per US tablespoon. Typically, trans fats occur naturally in meat and milk from ruminants.

“Kombucha” is a fermented, slightly alcoholic, lightly effervescent, sweetened black or green tea drink commonly consumed for its supposed health benefits, Sometimes the beverage is called kombucha tea to distinguish it from the culture of bacteria and yeast.

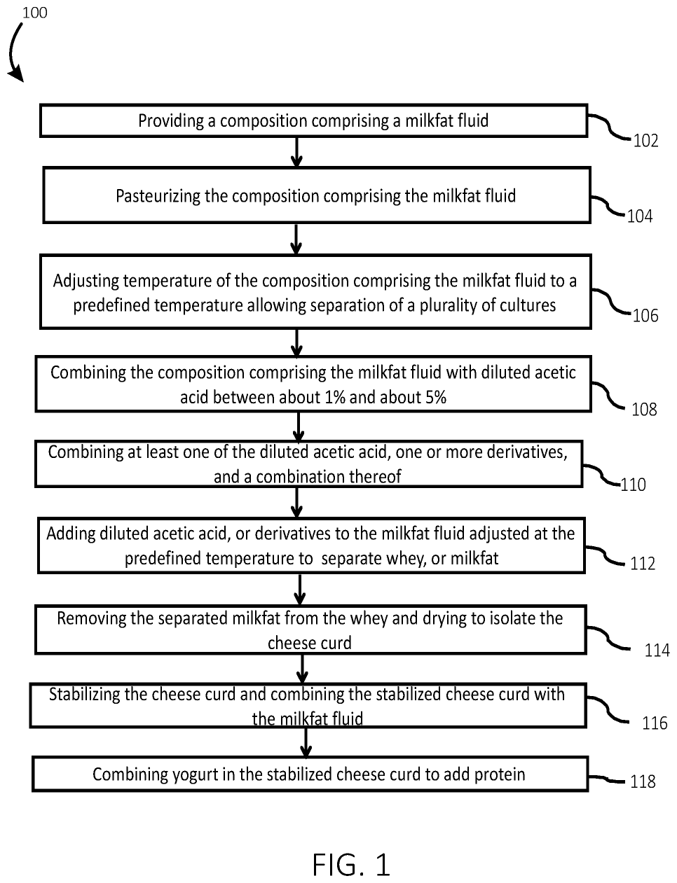

FIG. 1 illustrates a flowchart of the method 100 of producing cheese curd, in accordance with an alternative embodiment of the present invention. The method includes the step 102 of providing a composition including a milkfat fluid. The method includes the step 104 of pasteurizing the composition including the milkfat fluid. The method includes the step 106 of adjusting temperature of the composition including the milkfat fluid to a predefined temperature allowing separation of a plurality of cultures. In an embodiment, the predefined temperature facilitates the milkfat to be separated to achieve the correct consistency of cheese product that can be dried and stabilized enough to last the duration of shelf life is between about 150 degrees Celsius and 170 degrees Celsius.

The method includes the step 108 of combining the composition including the milkfat fluid with diluted acetic acid between about 1% and about 0.5%. The method includes the step 110 of combining at least one of the diluted acetic acid, one or more derivatives, and a combination thereof. In an embodiment, the one or more derivatives include but not limited to one or more fruits, vinegar, and kombucha.

The method includes the step 112 of adding at least one of the diluted acetic acid, the one or more derivatives, and a combination thereof to the milkfat fluid adjusted at the predefined temperature to separate at least one of whey, milkfat or butterfat, and a combination thereof. In an embodiment, during separation process, the quantity of milkfat fluid is one gallon which is added to ¼ cup of acidic acid added to correct/predefined temperature milkfat fluid.

The method includes step 114 of removing the separated milkfat from the whey and drying to isolate the cheese curd. The method includes the step 116 of stabilizing the cheese curd and combining the stabilized cheese curd with the milkfat fluid. In an embodiment, natural colouring is added during stabilizing the cheese curd to signify a flavour profile such as blue for blueberry, red for strawberry etc. The natural coloring process does not break down the protein curds and remain intact during the shelf life of the product. The addition of the natural colouring allows for no other colour additives to be used in the core yogurt product when mixed.

The method includes the step 118 of combining yogurt in the stabilized cheese curd to add protein. The cheese curd remains stabilized after combining the yogurt. In an embodiment, 4 ounce (oz) of yogurt combined with 2 oz of dry curd cottage cheese to the stabilized portions. The separation of the high protein curds added to the yogurt naturally increases the protein without added carbohydrates, sodium, fat or sugars. Curd is full of calcium, vitamin D, protein and healthy gut bacteria.

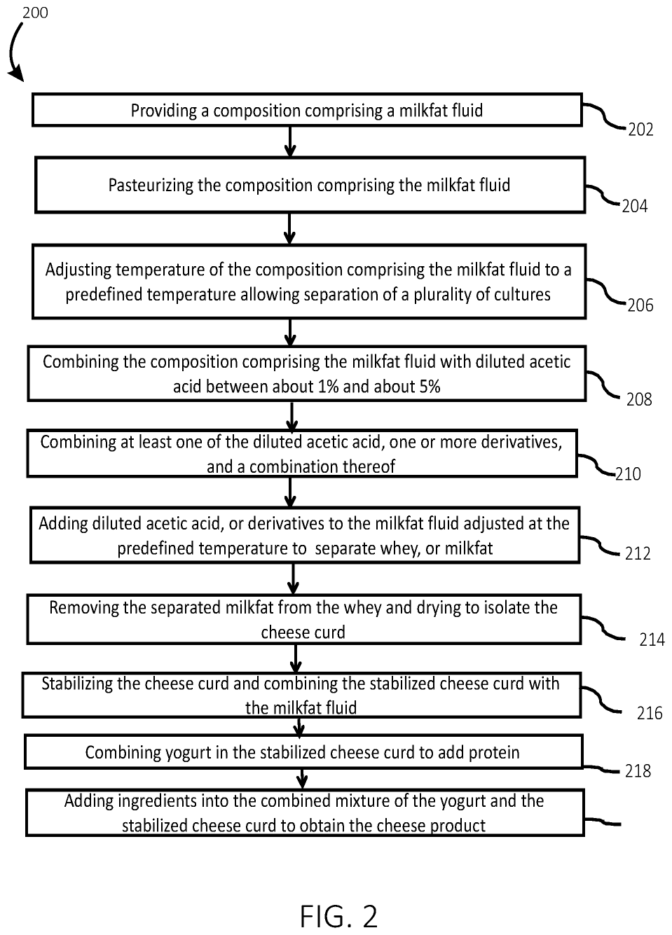

FIG. 2 illustrates a flowchart of the present method 200 of producing a cheese product, in another embodiment of the present invention. The method includes the step 202 of providing a composition including a milkfat fluid. The method includes the step 204 of pasteurizing the composition including the milkfat fluid. The method includes the step 206 of adjusting temperature of the composition including the milkfat fluid to a predefined temperature allowing separation of a plurality of cultures. The method includes the step 208 of combining the composition including the milkfat fluid with diluted acetic acid between about 1% and about 0.5%. The method includes the step 210 of combining at least one of the diluted acetic acid, one or more derivatives, and a combination thereof in an embodiment, one or more derivatives include but not limited to one or more fruits, vinegar, and kombucha.

The method includes the step 212 of adding at least one of the diluted acetic acid, the one or more derivatives, and a combination thereof to the milkfat fluid adjusted at the predefined temperature to separate at least one of whey, milkfat or butterfat, and a combination thereof. The method includes the step 214 of removing the separated milkfat from the whey and drying to isolate the cheese curd. The method includes the step 216 of stabilizing the cheese curd and combining the stabilized cheese curd with the milkfat fluid. The method includes the step 218 of combining yogurt in the stabilized cheese curd to add protein. The cheese curd remains stabilized after combining the yogurt. The method includes step 220 of adding one or more ingredients into the combined mixture of the yogurt and the stabilized cheese curd to obtain the cheese product. In an embodiment, the present present method of separating the curd from the milk results in a clean separation from the whey and then dried. The protein curd remains but is stabilized in yogurt and will not break down. The process of creating dry cheese curd is a combination of heated temperature and the separation of protein and whey using various natural separators or derivatives. Those separators include but not limited to natural fruit juice, vinegar or kombucha or other all natural separators.

Thus the present method provides an efficient, simpler and more elegant composition that combines yogurt and cheese curds to increase the protein content. The present method produces sustainable cheese curd products having improved properties to stabilize in the yogurt and naturally add protein without adding sugar, calories, carbohydrates or unnecessary fats. The curd products are produced as a result of methods used to separate the curd protein and combined with using kombucha and yogurt to improve probiotic health benefits.

While embodiments of the present invention have been illustrated and described, it will be clear that the invention is not limited to these embodiments only. Numerous modifications, changes, variations, substitutions, and equivalents will be apparent to those skilled in the art, without departing from the scope of the invention, as described in the claims.

What is claimed is:

1. A method of producing cheese curd, the method comprises the steps of:
providing a composition comprising a milkfat fluid;
pasteurizing the composition comprising the milkfat fluid;
adjusting temperature of the composition comprising the milkfat fluid to a predefined temperature allowing separation of a plurality of cultures;
combining the composition comprising the milkfat fluid with diluted acetic acid between about 1% and about 5%;
combining at least one of the diluted acetic acid, one or more derivatives, and a combination thereof;
adding at least one of the diluted acetic acid, the one or more derivatives, and a combination thereof to the milkfat fluid adjusted at the predefined temperature to separate at least one of whey, milkfat, and a combination thereof;
removing the separated milkfat from the whey and drying to isolate the cheese curd;
stabilizing the cheese curd and combining the stabilized cheese curd with the milkfat fluid; and
combining yogurt in the stabilized cheese curd to add protein, wherein the cheese curd remains stabilized after combining the yogurt.

2. The method according to claim 1, wherein the one or more derivatives comprises one or more fruits, vinegar, and kombucha.

3. A method of producing a cheese product, the method comprises the steps of:
providing a composition comprising a milkfat fluid;
pasteurizing the composition comprising the milkfat fluid;
adjusting temperature of the composition comprising the milkfat fluid to a predefined temperature allowing separation of a plurality of cultures;
combining the composition comprising the milkfat fluid with diluted acetic acid between about 1% and about 5%;
combining at least one of the diluted acetic acid, one or more derivatives, and a combination thereof;
adding at least one of the diluted acetic acid, the one or more derivatives, and a combination thereof to the milkfat fluid adjusted at the predefined temperature to separate at least one of whey, milkfat, and a combination thereof;
removing the separated milkfat from the whey and drying to isolate the cheese curd;
stabilizing the cheese curd and combining the stabilized cheese curd with the milkfat fluid;
combining yogurt in the stabilized cheese curd to add protein, wherein the cheese curd remains stabilized after combining the yogurt; and
adding the one or more ingredients into the combined mixture of the yogurt and the stabilized cheese curd to obtain the cheese product.

4. The method according to claim 3, wherein the one or more derivatives comprises one or more fruits, vinegar, and kombucha.
